(19) United States
(12) Patent Application Publication
(10) Pub. No.: US 2007/0121723 A1
(43) Pub. Date: May 31, 2007

(54) Scalable video coding method and apparatus based on multiple layers

(75) Inventors: Manu Mathew, Suwon-si (KR); Kyo-hyuk Lee, Seoul (KR); Woo-Jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/585,981

(22) Filed: Oct. 25, 2006

Related U.S. Application Data
(60) Provisional application No. 60/740,251, filed on Nov. 29, 2005.
(60) Provisional application No. 60/757,899, filed on Jan. 11, 2006.
(60) Provisional application No. 60/759,966, filed on Jan. 19, 2006.

(30) Foreign Application Priority Data
Mar. 23, 2006 (KR) 10-2006-0026603

(51) Int. Cl. H04N 7/12; H04N 11/04

(52) U.S. Cl. 375/240.12

(57) ABSTRACT

A scalable video encoding method and apparatus based on a plurality of layers are provided. The video encoding method for encoding a video sequence having a plurality of layers includes coding a residual of a first block existing in a first layer among the plurality of layers; recording the coded residual of the first block on a non-discardable region of a bitstream, if a second block is coded using the first block, the second block existing in a second layer among the plurality of layers and corresponding to the first block; and recording the coded residual of the first block on a discardable region of the bitstream, if a second block is coded without using the first block.

### CROSS-REFERENCE TO RELATED APPLICATIONS

This application claims priority from Korean Patent Application No. 10-2006-0026603 filed on Mar. 23, 2006 in the Korean Intellectual Property Office, and the benefit of priority from U.S. Provisional Patent Application No. 60/740,251 filed on Nov. 29, 2005, 60/757,899 filed on Jan. 11, 2006, and 60/759,966 filed on Jan. 19, 2006, in the United States Patent and Trademark Office, the disclosures of each of which are incorporated herein by reference in their entirety.

### BACKGROUND OF THE INVENTION

1. Field of the Invention

Methods and apparatuses consistent with the present invention relate to video coding, and more particularly, to a scalable video coding method and apparatus based on multiple layers.

2. Description of the Related Art

With the development of information communication technology including the Internet, video communication as well as text and voice communication has rapidly increased. Conventional text communication cannot satisfy various user demands, and thus multimedia services that can provide various types of information such as text, pictures, and music have increased. Multimedia data requires a large capacity of storage media and a wide bandwidth for transmission since the amount of multimedia data is usually large in relative terms to other types of data. Accordingly, a compression coding method is required for transmitting multimedia data including text, video, and audio.

In such a compression coding method, a basic principle of data compression lies in removing data redundancy. Data redundancy is typically defined as spatial redundancy in which the same color or object is repeated in an image, temporal redundancy in which there is little change between adjacent frames in a moving image or the same sound is repeated in audio, or mental visual redundancy taking into account human eyesight and perception dull to high frequency. In general video coding techniques, temporal redundancy is removed by temporal filtering based on motion compensation, and spatial redundancy is removed by spatial transformation.

To transmit multimedia generated after removing data redundancy, transmission media are necessary. Transmission performance is different depending on the transmission media. Transmission media in current use have various transmission rates. For example, an ultrahigh-speed communication network can transmit data of several tens of megabits per second while a mobile communication network has a transmission rate of 384 kilobits per second. Accordingly, to support transmission media having various speeds or to transmit multimedia at a data rate suitable to a transmission environment, data coding methods having scalability, such as a wavelet video coding or a subband video coding or other similar coding method, may be suitable to a multimedia environment.

Scalable video coding is a technique that allows a compressed bitstream to be decoded at different resolutions, frame rates, and signal-to-noise ratio (SNR) levels by truncating a portion of the bitstream according to ambient conditions such as transmission bit rates, error rates, and system resources.

Motion Picture Experts Group 4 (MPEG 4) standardization for scalable video coding (SVC) is under way by a Joint Video Team (JVT), which is a joint working group of MPEG and International Telecommunication Union (ITU). In particular, much effort is being made in standardization for achieving multi-layered scalability based on H.264 standard.

FIG. 1 is a diagram illustrating a simulcasting procedure through a related art transcoding process. An encoder 11 generates non-scalable bitstreams and supplies the same to router/transcoders 12, 13 and 14 serving as streaming servers. The router/transcoders 13 and 14 connected to end-client devices, such as a high definition television (HDTV) 15, a digital multimedia broadcasting (DMB) receiver 16, a personal digital assistant (PDA) 17 and a mobile phone 18, or similar device, transmit bitstreams having various quality levels according to the performance of the end-client devices or network bandwidths. Since the transcoding process performed by the transcoders 12, 13 and 14 involves decoding of input bitstreams and reencoding of the decoded bitstreams using other parameters, some time delay is caused and a deterioration of the video quality is unavoidable.

In view of the above problems, the SVC standards provide for scalable bitstreams in consideration of a spatial dimension (spatial scalability), a frame rate (temporal scalability), or a bitrate (SNR scalability), which are considerably advantageous scalable features in a case where a plurality of clients receive the same video, while having different spatial/temporal/quality parameters. Accordingly, since no transcoder is required for scalable video coding, efficient multicasting is attainable.

According to the SVC standards, as shown in FIG. 2, an encoder 11 generates scalable bitstreams, and router/extractors 22, 23, 24, which have received the scalable bitstreams from the encoder 11, simply extract some of the received scalable bitstreams, thereby changing the quality of the bitstreams. Therefore, the router/extractors 22, 23, 24 enable streamed contents to be better controlled, thereby achieving efficient use of available bandwidths.

FIG. 3 shows an example of a scalable video codec using a multi-layered structure. Referring to FIG. 1, a base layer has a quarter common intermediate format (QCIF) resolution and a frame rate of 15 Hz, a first enhanced layer has a common intermediate format (CIF) resolution and a frame rate of 30 Hz, and a second enhanced layer has a standard definition (SD) resolution and a frame rate of 60 Hz. For example, to obtain a stream having a CIF resolution and a bit rate of 0.5 Mbps, the enhanced layer bitstream having a CIF resolution, a frame rate of 30 Hz and a bit rate of 0.7 Mbps may be truncated to meet the bit rate of 0.5 Mbps. In this way, it is possible to implement spatial, temporal, and SNR scalabilities.

However, such scalability may often cause overhead. FIGS. 4 and 5 are graphical representations is a graph for comparing quality of a non-scalable bitstream coded in accordance with the H.264 standard with quality of a scalable bitstream coded in accordance with the SVC standard. In a scalable bitstream, a peak signal-to-noise ratio (PSNR) loss of about 0.5 dB is observed. In such an extreme case as shown in FIG. 5, the PSNR loss is almost 1 dB. Referring to FIGS. 4 and 5, analysis results show that the SVC codec performance (e.g., for spatial scalability) is close to or slightly higher than the MPEG-4 codec performance, which is lower than the H.264 codec performance. In this case, about 20% of a bitrate overhead is caused depending on scalability.

Referring back to FIG. 2, the last link (i.e., a link between the last router and the last client) also uses a scalable bitstream. In most cases, however, only a single client receives the bitstream in the link, suggesting that scalability features are not required. Thus, a bandwidth overhead is generated in the last link. Accordingly, there is a need to propose a technique of adaptively reducing the overhead when scalability is not required.

### SUMMARY OF THE INVENTION

The present invention provides a multi-layered video codec having improved coding performance.

The present invention also provides a method of removing the overhead of a scalable bitstream when scalability is not required in the scalable bitstream.

These and other aspects of the present invention will be described in or be apparent from the following description of exemplary embodiments.

According to an aspect of the present invention, there is provided a video encoding method for encoding a video sequence having a plurality of layers, the method including coding a residual of a first block existing in a first layer among the plurality of layers, recording the coded residual of the first block on a non-discardable region of a bitstream, if a second block is coded using the first block, the second block existing in a second layer among the plurality of layers and corresponding to the first block, and recording the coded residual of the first block on a discardable region of the bitstream, if a second block is coded without using the first block.

According to another aspect of the present invention, there is provided a video decoding method for decoding a video bitstream including at least one layer having a non-discardable region and a discardable region, the method including reading a first block from the non-discardable region, decoding data of the first block if the data of the first block exists, reading data of a second block having a same identifier as the first block from the discardable region if no data of the first block exists, and decoding the read data of the second block.

According to still another aspect of the present invention, there is provided a video encoder for encoding a video sequence having a plurality of layers, the video encoder including a coding unit that codes a residual of a first block existing in a first layer among the plurality of layers, a recording unit that records the coded residual of the first block on a non-discardable region of a bitstream, if a second block is coded using the first block, the second block existing in a second layer among the plurality of layers and corresponding to the first block, and a recording unit that records the coded residual of the first block on a discardable region of the bitstream, if a second block is coded without using the first block.

According to a further aspect of the present invention, there is provided a video decoder for decoding a video bitstream including at least one layer having a non-discardable region and a discardable region, the video decoder including a reading unit that reads a first block from the non-discardable region, a decoding unit that decodes data of the first block if the data of the first block exists, a reading unit that reads data of a second block having a same identifier as the first block from the discardable region if no data of the first block exists, and a decoding unit that decodes the read data of the second block.

### BRIEF DESCRIPTION OF THE DRAWINGS

The above and other aspects of the present invention will become more apparent by describing in detail certain exemplary embodiments thereof with reference to the attached drawings in which:

FIG. 1 is a diagram illustrating a simulcasting procedure through a related art transcoding process;

FIG. 2 is a diagram showing a bitstream transmission procedure in accordance with a related art SVC standard;

FIG. 3 is a diagram showing an example of a scalable video codec using a multi-layered structure;

FIGS. 4 and 5 are graphical representations for comparing quality of a non-scalable bitstream coded in accordance with the H.264 standard with quality of a scalable bitstream coded in accordance with the SVC standard;

FIG. 6 is a diagram showing a bitstream transmission procedure in accordance with an exemplary embodiment of the present invention;

FIG. 7 schematically shows the overall format of a bitstream in accordance with a related art H.264 standard or SVC standard;

FIG. 8 schematically shows the overall format of a bitstream in accordance with an exemplary embodiment of the present invention;

FIG. 9 is a diagram for explaining the concept of Inter prediction, Intra prediction and Intra base prediction;

FIG. 10 is a flowchart showing a video encoding process in accordance with an exemplary embodiment of the present invention;

FIG. 11 shows an example of the detailed structure of the bitstream shown in FIG. 8;

FIG. 12 is a flowchart showing a video decoding process performed by a video decoder in accordance with an exemplary embodiment of the present invention;

FIG. 13 is a diagram showing a video sequence consisting of three layers;

FIG. 14 is a diagram showing an example of a bitstream in a finite granular scalability (FGS) video, to which multiple adaptation can be applied;

FIG. 15 is a diagram showing an example of a dead substream in a FGS video, to which multiple adaptation cannot be applied;

FIG. 16 is a diagram showing an example of multiple adaptation using temporal levels;

FIG. 17 is a diagram showing an example of multiple adaptation using temporal levels in accordance with an exemplary embodiment of the present invention;

FIG. 18 is a diagram showing an example of temporal prediction between course granular scalability (CGS) layers;

FIG. 19 is a diagram showing an example of temporal prediction between a CGS layer and a FGS layer;

FIG. 20 is a block diagram of a video encoder in accordance with an exemplary embodiment of the present invention; and

FIG. 21 is a block diagram of a video decoder in accordance with an exemplary embodiment of the present invention.

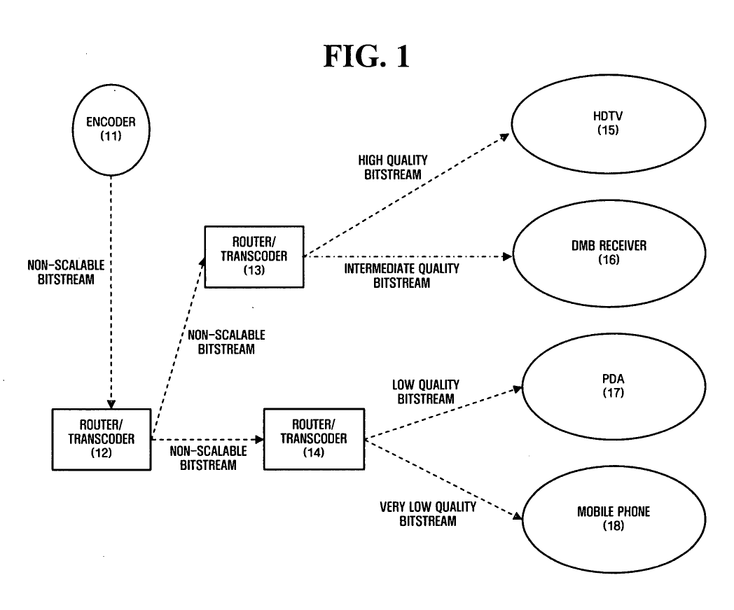

### DETAILED DESCRIPTION OF EXEMPLARY EMBODIMENTS OF THE PRESENT INVENTION

Exemplary embodiments are described below to explain the present invention by referring to the figures.

Scalability often incurs overhead. However, in a streaming system, if a client does not need a scalable bitstream, a router transmitting a bitstream to the client may select a non-scalable bitstream to transmit the same to the client, the non-scalable bitstream having a lower bitrate than the scalable bitstream.

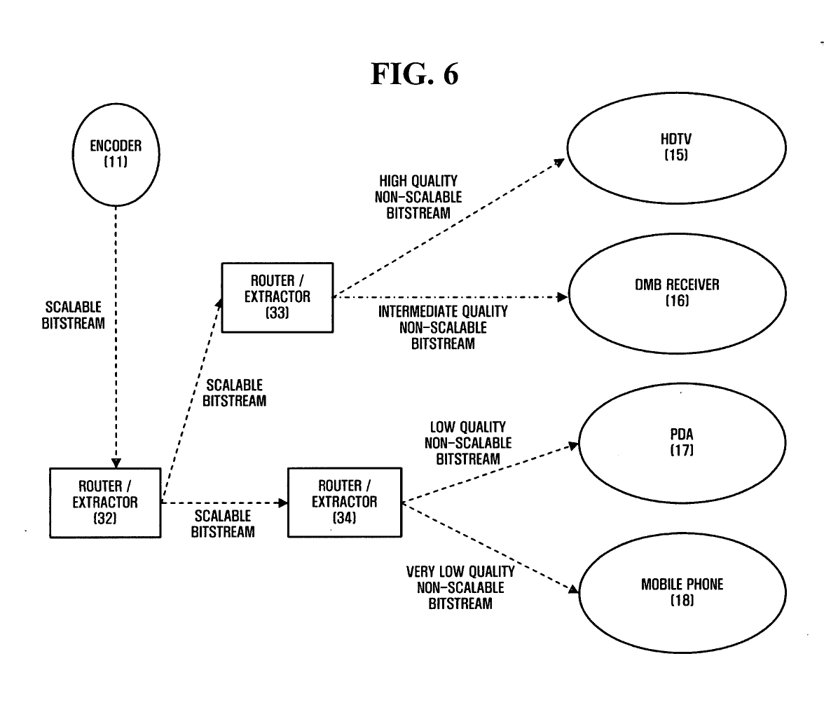

FIG. 6 is a diagram showing a bitstream transmission procedure in accordance with an exemplary embodiment of the present invention. An encoder 11 generates scalable bitstreams and supplies the same to router/extractors 32, 33 and 34 serving as streaming servers. The extractors 33 and 34 connected to end-client devices, such as HDTV 15, DMB receiver 16, PDA 17 and mobile phone 18 perform transform on their corresponding scalable bitstreams into non-scalable bitstreams suitably according to the performance of the end-client devices or network bandwidths for transmission. Since overhead for maintaining scalability is removed while performing the transform, the video quality at the end-client devices 15, 16, 17 and 18 can be enhanced.

Such bitstream transform upon client's demand is often called “multiple adaptation” as well. To enable such bitstream transform, a scalable bitstream advantageously has a format in which the scalable bitstream can be easily transformed into a non-scalable bitstream. Terms to be used in the specification will now be described briefly.

Discardable Information

Discardable information is information that is required for decoding a current layer but is not required for decoding an enhancement layer.

Non-Discardable Information

Non-discardable information is information that is required for decoding an enhancement layer.

In exemplary embodiments of the present invention, a scalable bitstream comprises discardable information and non-discardable information, which are to be easily separable from each other. In other words, the discardable information and the non-discardable information should be separated from each other by means of two different coding units (e.g., NAL units used in H.264). If it is determined that the final router is not needed by a client, the discardable information of the scalable bitstream is discarded.

Such a scalable bitstream according to the present invention is referred to as a “switched scalable bitstream.” The switched scalable bitstream is in a form in which a discardable bit and a non-discardable bit can be separated from each other. A bitstream extractor is configured to easily discard discardable information when it is determined that the discardable information is not needed by a client. Accordingly, switching from a scalable bitstream to a non-scalable bitstream is facilitated.

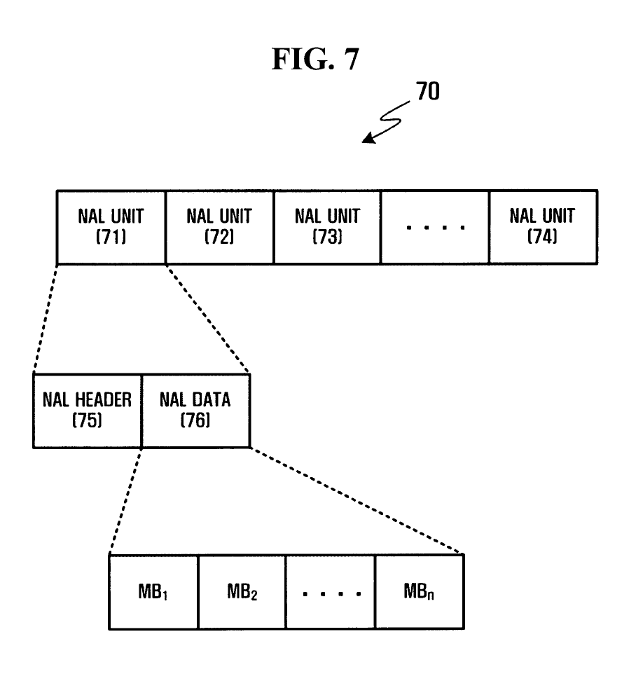

FIG. 7 schematically shows the overall format of a bitstream in accordance with a related art H.264 standard or SVC standard. In the related art H.264 standard or SVC standard, a bitstream 70 is composed of a plurality of Network Abstraction Layer (NAL) units 71, 72, 73 and 74. Some of the NAL units 71, 72, 73 and 74 in the bitstream 70 are extracted by an extractor (not shown) to change video quality. Each of the plurality of NAL units 71, 72, 73 and 74 comprises a NAL data field 76 in which compressed video data is recorded, and a NAL header 75 in which additional information about the compressed video data is recorded.

A size of the NAL data field 76, which is not fixed, is generally recorded on the NAL header 75. The NAL data field 76 may comprises one or more (n) macroblocks MB₁, MB₂, . . . and MBₙ. A macroblock includes motion data such as motion vectors, macroblock patterns, reference frame number, or the like, and texture data such as quantized residuals, or the like.

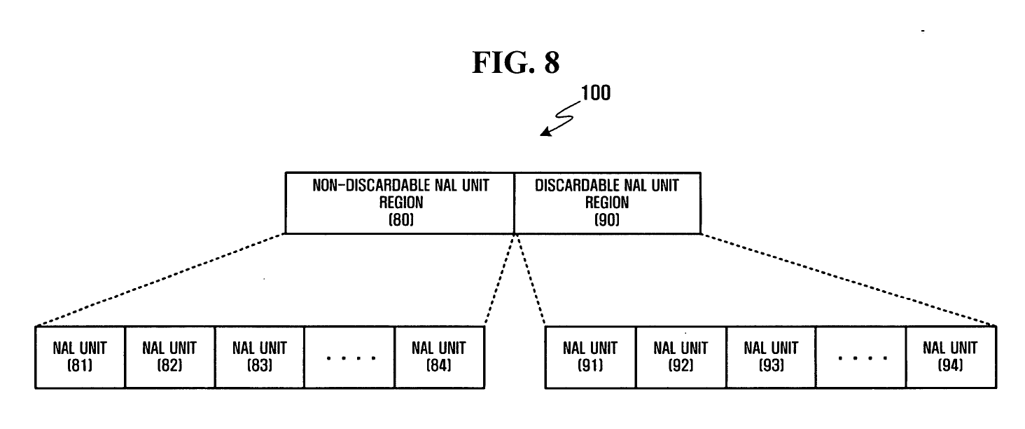

FIG. 8 schematically shows the overall format of a bitstream 100 in accordance with an exemplary embodiment of the present invention. The bitstream 100 in accordance with an exemplary embodiment of the present invention is composed of a non-discardable NAL unit region 80 and a discardable NAL unit region 90. A NAL header of NAL units 81, 82, 83 and 84 of the non-discardable NAL unit region 80 is set to 0 as a discardable_flag indicating whether the NAL units 81, 82, 83 and 84 are discardable or not, and a NAL header of NAL units 91, 92, 93 and 94 of the discardable NAL unit region 90 is set to is set to 1.

A value of 0 set as the discardable_flag denotes that data recorded in a NAL data field of a NAL unit is used in the decoding process of an enhancement layer while a value of 1 set as the discardable_flag denotes that data recorded in a NAL data field of a NAL unit is not used in the decoding process of an enhancement layer.

To represent texture data with improved compression efficiency, the SVC standard describes four prediction methods, including inter prediction, which is also used in the existing H.264 standard, directional intra prediction, which is simply called intra prediction, intra base prediction, which is available only with a multi-layered structure, and residual prediction. The term “prediction” used herein means to indicate a technique of representing original image in a compressive manner using predicted data derived from information commonly used by an encoder and a decoder.

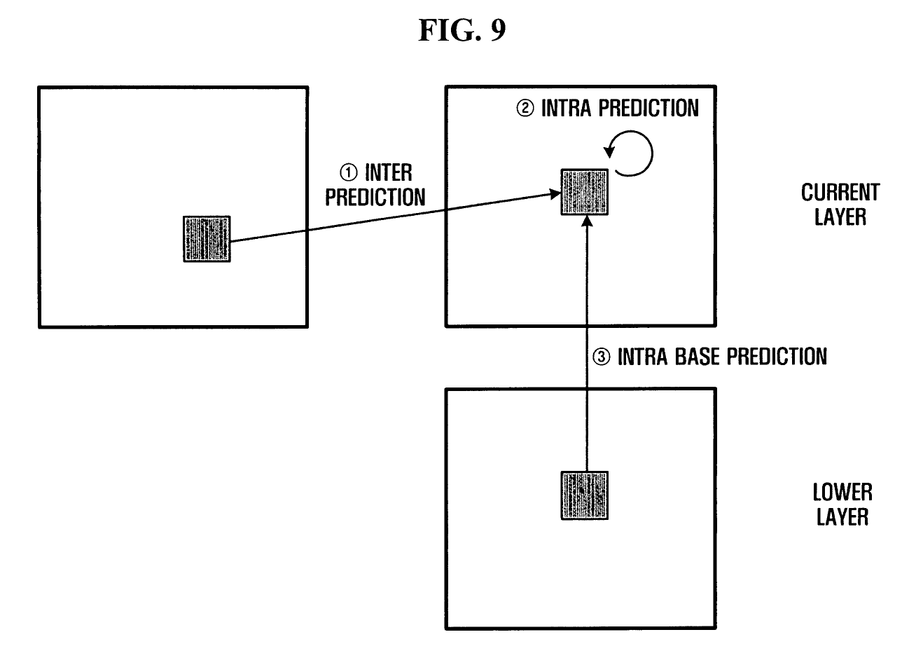

FIG. 9 is a diagram for explaining the concept of Inter prediction, Intra prediction and Intra base prediction.

Inter prediction is a scheme that is generally used in an existing single-layered video codec. Referring to FIG. 9, inter prediction is a scheme in which a block that is the most similar to a current block of a current picture is searched from a reference picture to obtain a predicted block, which can best represent the current block, followed by quantizing a residual between the predicted block and the current block. There are three types of inter prediction according to the method of referring to a reference picture: bidirectional prediction in which two reference pictures are used; forward prediction in which a previous reference picture is used; and backward prediction in which a subsequent reference picture is used.

Intra prediction is a scheme in which a current block is predicted using adjacent pixels of the current block among neighboring blocks of the current block. The intra prediction is different from other prediction schemes in that only information from a current picture is exploited and that neither different pictures of a given layer nor pictures of different layers are referred to.

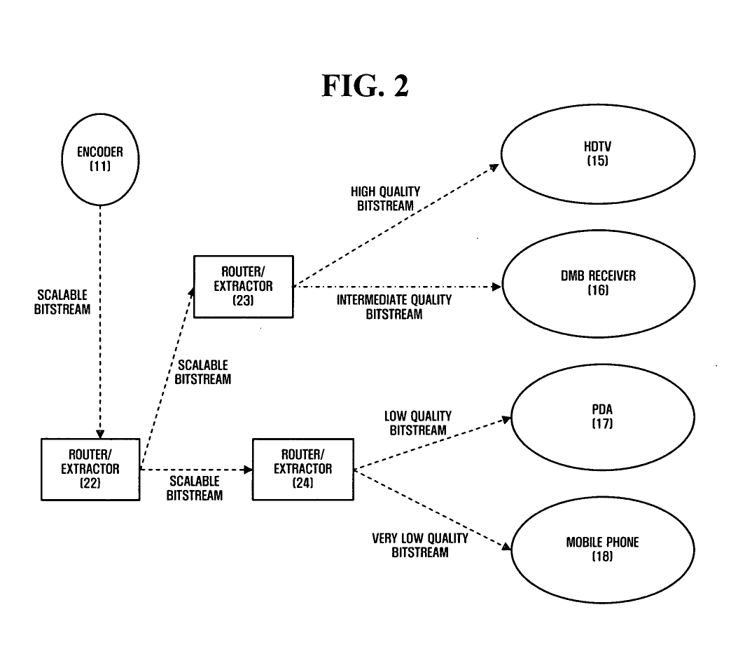

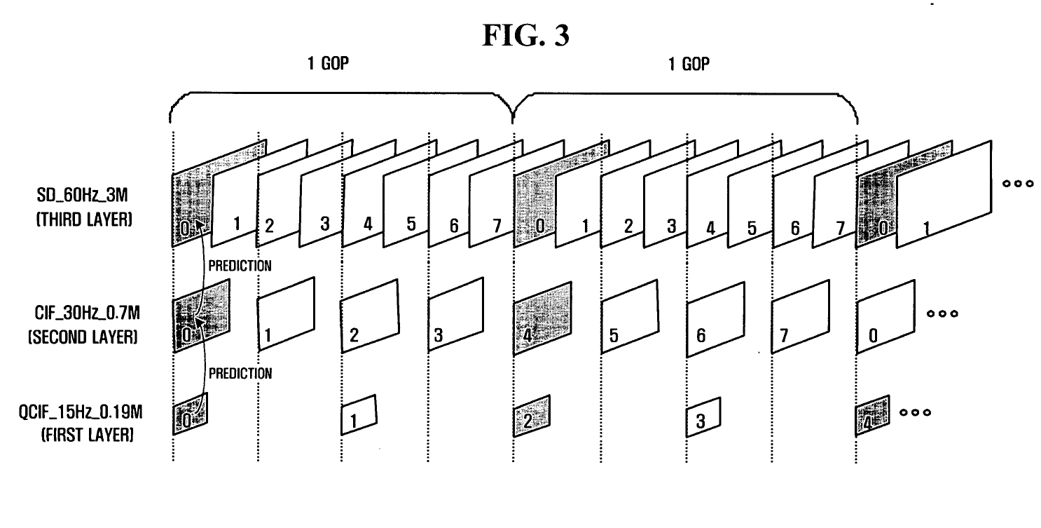

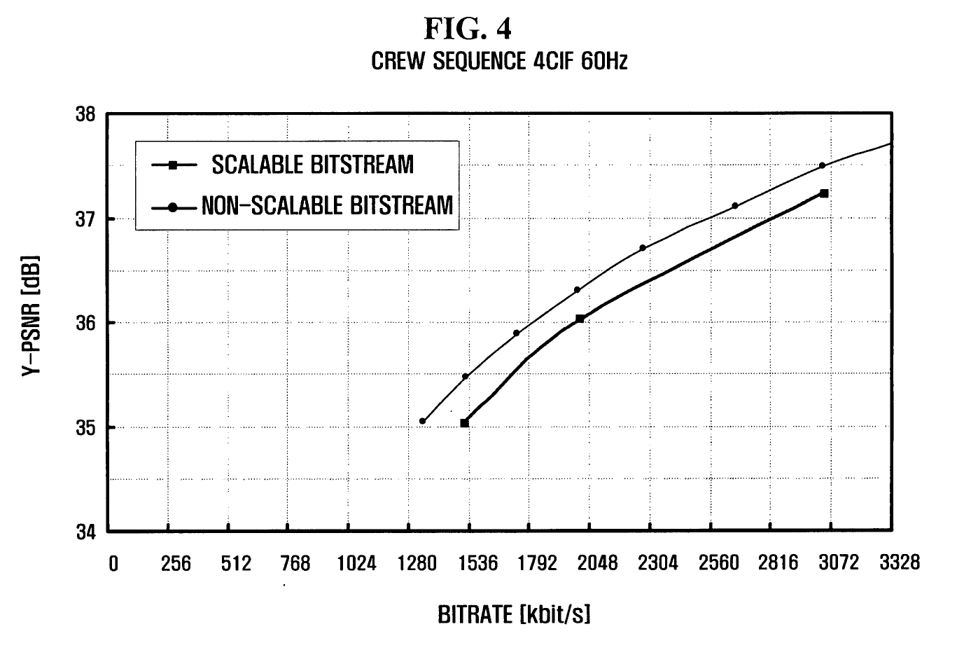

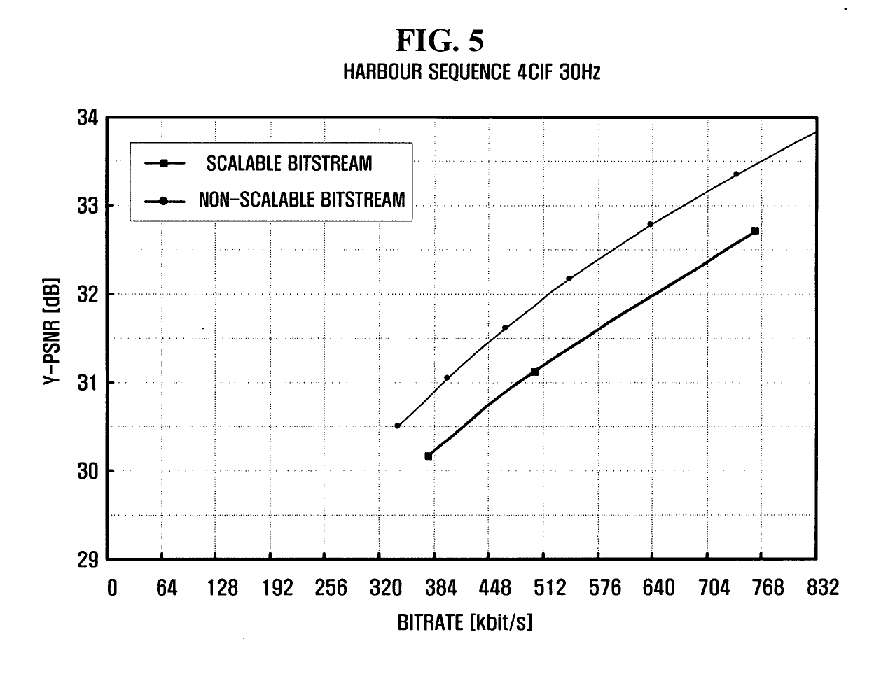

Intra base prediction is used when a current picture has one block among blocks positioned at a frame temporally simultaneous with a macroblock of a lower layer. As shown in FIG. 2, a macroblock of the current picture can be efficiently predicted from the macroblock of the base layer picture corresponding to the macroblock. That is to say, a difference between the macroblock of the current picture and the macroblock of the base layer picture is quantized.

When a resolution of a lower layer is different from a resolution of a current layer, prior to obtaining the macroblock difference, the macroblock of the base layer picture is upsampled. The intra base prediction is efficiently used particularly when the inter prediction scheme is not efficient, for example, when picture images move very fast or there is a picture image having a scene change.

Finally, although not shown in FIG. 9, residual prediction, which is an extension from the existing inter prediction for a single layer, is suitably used with multiple layers. That is to say, a difference created in the inter prediction process of the current layer is not quantized but a subtraction result of the difference and a difference created in the inter prediction process of the lower layer is quantized.

The discardable_flag may be set to a certain value, which may be predetermined, based on one scheme selected among the four prediction schemes used in encoding a macroblock of an enhancement layer corresponding to the macroblock of the current picture. For example, if the macroblock of an enhancement layer is encoded using intra prediction or inter prediction, the current macroblock is used only for supporting scalability but is not used for decoding the macroblock of the enhancement layer. Accordingly, in this case, the current macroblock may be included in a discardable NAL unit. On the other hand, if the macroblock of an enhancement layer is encoded using intra base prediction or residual prediction, the current macroblock is needed for decoding the macroblock of the enhancement layer. Accordingly, in this case, the current macroblock may be included in a non-discardable NAL unit. It is possible to know which prediction scheme has been employed in encoding the macroblock of the enhancement layer by reading intra_base_flag and residual_prediction_flag based on the SVC standard. In other words, if the intra_base_flag of the macroblock of the enhancement layer is set to 1, it can be known that intra base prediction has been employed in encoding the macroblock of the enhancement layer. On the other hand, if the residual_prediction_flag is set to 1, it can be known that residual prediction has been employed in encoding the macroblock of the enhancement layer.

A prediction scheme using information about macroblocks of different layers, e.g., intra base prediction or residual prediction, is referred to as inter-layer prediction.

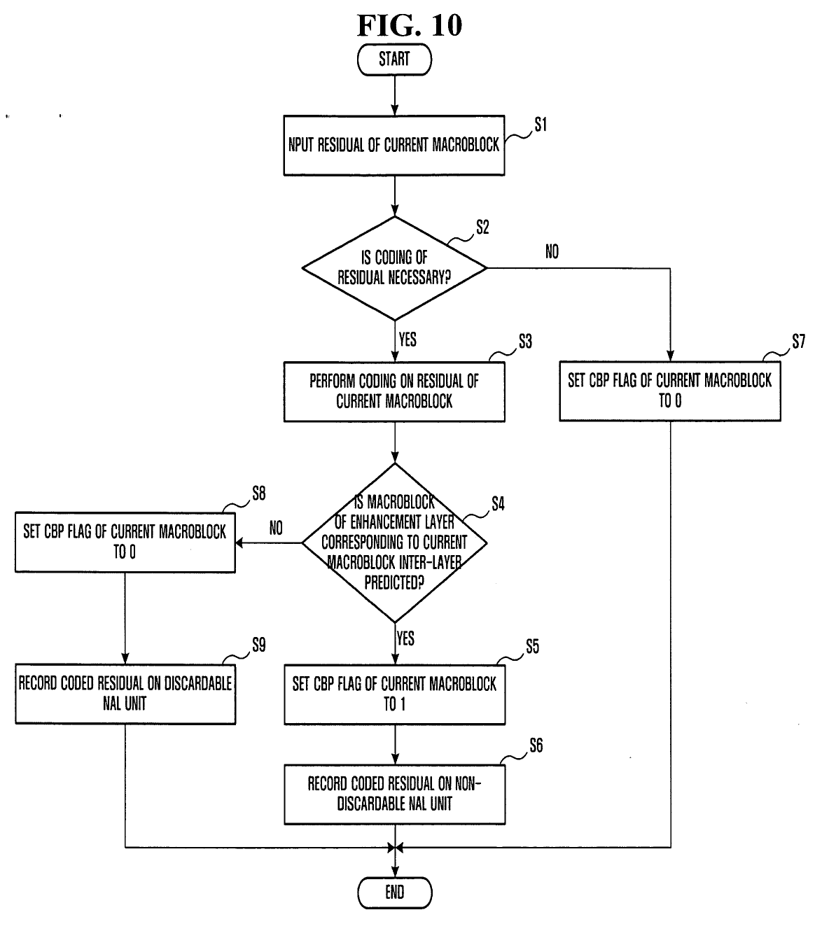

FIG. 10 is a flowchart showing a video encoding process in accordance with an exemplary embodiment of the present invention. A residual of a current macroblock is input in operation S1, a video encoder determines whether or not coding of the residual is necessary in operation S2. In general, when residual energy (sum of the absolute value or square value of the residual) is smaller than a threshold value, it is determined that the coding of the residual is not necessary, that is, the residual is considered as being 0, and coding is not performed. The threshold value may be predetermined.

In operation S2, if it is determined that the coding of the residual is not necessary (i.e., “NO” in operation S2), a Coded Block Pattern (CBP) flag of the current macroblock is set to 0 in operation S7. According to the SVC standard, a CBP flag is set in each macroblock to indicate whether a given block has been coded or not. A video decoder reads the set CBP flag to determine whether a given macroblock has been decoded or not.

In operation S2, if it is determined that the coding of the residual is necessary (i.e., “YES” in operation S2), a video encoder performs coding on the residual of the current macroblock in operation S3. The coding technique may comprise a spatial transform such as a discrete cosine transform (DCT) or wavelet transform or other similar transform, quantization, entropy coding such as variable length coding or arithmetic coding, and the like.

The video encoder determines whether the macroblock of an enhancement layer corresponding to the current macroblock has been inter-layer predicted or not in operation S4. As described above, information about whether the macroblock of an enhancement layer corresponding to the current macroblock has been inter-layer predicted or not can be obtained by reading the intra_base_flag and residual_prediction_flag.

In operation S4, if it is determined that the macroblock of an enhancement layer corresponding to the current macroblock has been inter-layer predicted (i.e., “YES” in operation S4), the video encoder sets the CBP flag for the current macroblock is set to 1 in operation S5. The coded residual of the current macroblock is recorded on the non-discardable NAL unit region 80 in operation S6.

In operation S4, if it is determined that the macroblock of an enhancement layer corresponding to the current macroblock has not been inter-layer predicted (i.e., “NO” in operation S4), the video encoder sets the CBP flag for the current macroblock is set to 0 and recorded on the non-discardable NAL unit region 80 in operation S8. Then, the coded residual of the current macroblock is recorded on the non-discardable NAL unit region 90 and the corresponding CBP flag is set to 1 in operation S9.

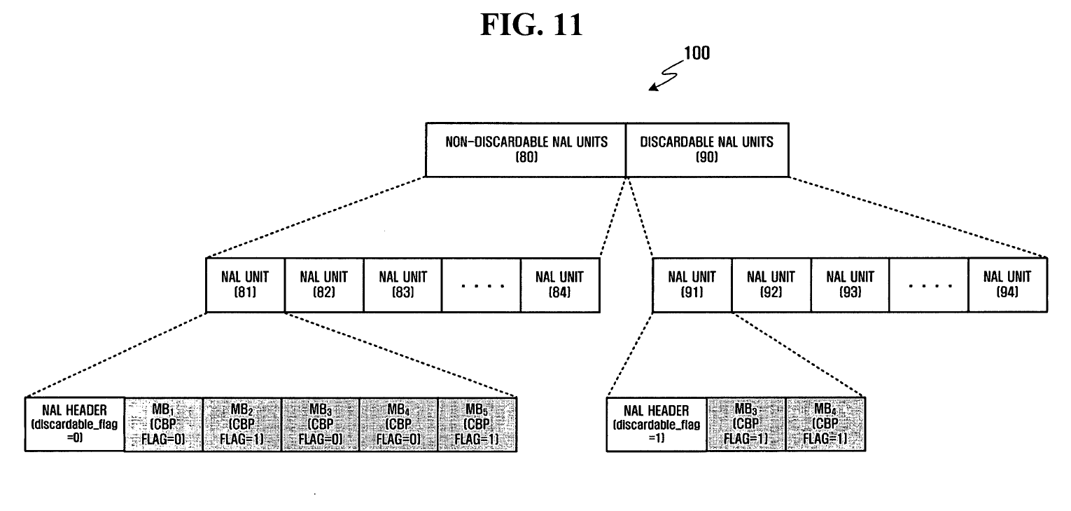

FIG. 11 shows an example of the detailed structure of the bitstream 100 having a residual of a macroblock (MBₙ) coded by a process described in the flowchart shown in FIG. 10, in which it is assumed that each NAL unit contains 5 macroblock data elements MB₁˜MB₅.

For example, an assumption is made that MB₁ is macroblock data in a case where the coding of the residual is not necessary (i.e., “NO” in operation S2 of FIG. 10), MB₂ and MB₅ are macroblocks in a case where the macroblocks of corresponding enhancement layers are inter-layer predicted (i.e., “YES” in operation S4 of FIG. 10), and MB₃ and MB₄ are macroblocks in a case where the macroblocks of corresponding enhancement layers are not inter-layer predicted (i.e., “NO” in operation S4 of FIG. 10).

Information signaling for a non-discardable NAL unit region is recorded on the NAL header of the NAL unit 81, which may be implemented by setting a discardable_flag to 0 in the NAL header of the NAL unit 81, for example.

A CBP flag of MB₁ is set to 0 and MB₁ is not coded nor recorded. That is to say, only a macroblock header including information about the CBP flag of MB₁ and motion information are recorded on the NAL unit 81. Then, MB₂ and MB₅ are recorded on the NAL unit 81 and each CBP flag thereof is set to 1.

In addition, since MB₃ and MB₄ are also macroblock data that are to be actually recorded, their CBP flags should be set to 1. However, to implement the switched scalable bitstream, the CBP flags of MB₃ and MB₄ are set to 0 and are not recorded on the NAL unit 81. Accordingly, MB₃ and MB₄ are considered from a viewpoint of the video decoder as if there were no data of coded macroblocks. However, even in the present invention, MB₃ and MB₄ are not absolutely discarded but are recorded on the NAL unit 91 for storage. Accordingly, information signaling for a discardable NAL unit region is recorded on the NAL header of the NAL unit 91, which may be implemented by setting a discardable_flag to 1 in the NAL header of the NAL unit 91, for example.

The NAL unit 91 includes at least discardable data among macroblock data included in the NAL unit 81. That is to say, MB₃ and MB₄ are recorded on the NAL unit 91. In this case, it is advantageous if CBP flags of MB₃ and MB₄ are set to 1. However, considering that macroblock data having a value of 0 as a CBP flag is not necessarily recorded on the NAL unit 91, either 1 or 0 as the CBP flags of MB₃ and MB₄ makes no difference.

A feature of the bitstream 100 shown in FIG. 11 lies in that it can be separated into discardable information and non-discardable information. Implementation of the feature of the bitstream 100 can avoid additional overhead. In order to maintain scalability during transmission of the bitstream 100 generated in the video encoder, the discardable information and the non-discardable information included in the bitstream 100 are left intact. On the contrary, when it is not necessary to maintain scalability during transmission of the bitstream 100, for example, when a transmission router is positioned at the last link, the discardable information is deleted. Even if the discardable information is deleted, only the scalability is abandoned and macroblocks of enhancement layers can be restored without any difficulty.

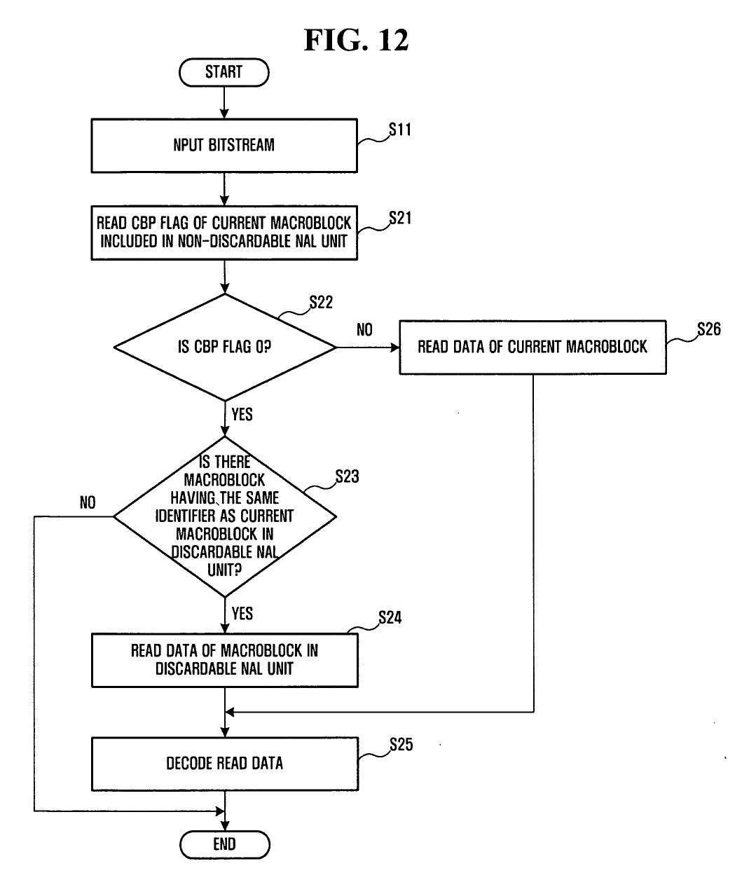

FIG. 12 is a flowchart showing a video decoding process performed on the bitstream 100 shown in FIG. 11 by a video decoder in accordance with an exemplary embodiment of the present invention. In a case where the bitstream 100 received by the video decoder includes discardable information and non-discardable information, a layer contained in the bitstream 100, i.e., a current layer, corresponds to the uppermost layer because when the video decoder decodes a bitstream of an enhancement layer of the current layer, the discardable NAL unit region should have been deleted from the bitstream of the current layer.

In operation S11, the video decoder receives the bitstream 100 and then reads a CBP flag of a current macroblock included in the discardable NAL unit region from the bitstream 100 in operation S21. Information about whether a NAL unit is discardable or not can be obtained by reading a discardable_flag recorded on a NAL header of the NAL unit.

If it is determined in operation S22 that the read CBP flag is 1 (i.e., “NO” in operation S22), the video decoder reads data recorded on the current macroblock in operation S26 and decodes the read data to restore an image corresponding to the current macroblock in operation S25.

If it is determined in operation S22 that the read CBP flag is 0, which means that there is no actually coded data or that even actually coded data is recorded in the discardable NAL unit region, the video decoder determines whether there is a macroblock having the same identifier as the current macroblock in the discardable NAL unit region or not in operation S23. The identifier denotes a number identifying a macroblock. In FIG. 11, although the CBP flag of MB₃ recorded on a NAL unit 82, which has an identifier of 3, is set to 0, the actually coded data thereof is recorded on MB₃ recorded on a NAL unit 91, which has an identifier of 3.

Thus, if there is a macroblock having the same identifier as the current macroblock in the discardable NAL unit region in operation S23 (i.e., “YES” in operation S23), the video decoder reads data of the macroblock in the discardable NAL unit region in operation S24. Then, the read data is decoded in operation S25.

Of course, the case where it is determined that there is a macroblock having the same identifier as the current macroblock in the discardable NAL unit region (i.e., “NO” in operation S23) corresponds to a case where there is no data that is actually coded in the current macroblock.

When the video encoder actually encodes a macroblock of the current block, it is difficult to know whether to use the macroblock of the current block in predicting a macroblock of an enhancement layer corresponding to the macroblock of the current block. Accordingly, it is advantageous to modify existing video coding schemes. There are two possible approaches to problems with the existing video coding schemes.

Approach 1: Modification of Encoding Process

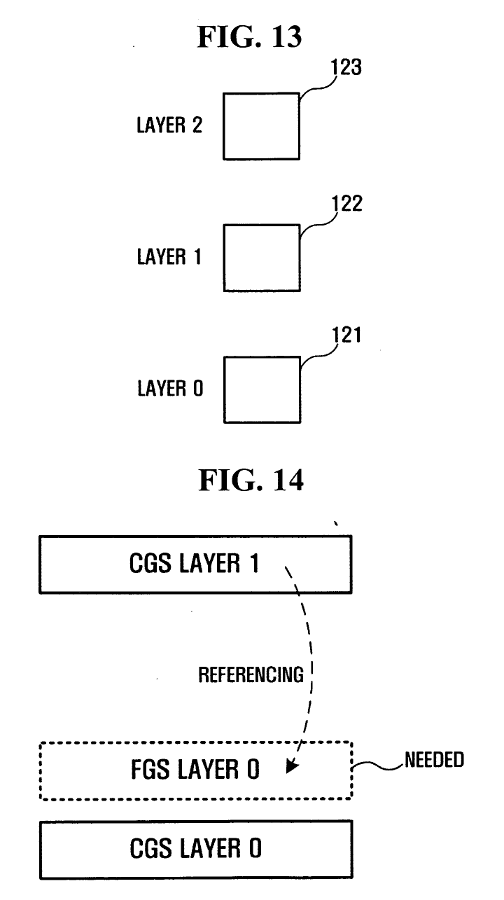

Approach 1 is to modify an encoding process to an extent. FIG. 13 is a diagram showing a video sequence consisting of three layers by way of example. A current layer cannot be encoded until enhancement layers thereof pass through a prediction process (inter prediction, intra prediction, intra base prediction, or residual prediction).

Referring to FIG. 13, a video encoder obtains a residual for a macroblock 121 of a layer 0 through a prediction process (inter prediction or intra prediction) and quantizes/inversely quantizes the obtained residual. The prediction process may be predetermined. Then, the video encoder obtains a residual for a macroblock 122 of a layer 1 through a prediction process (inter prediction, intra prediction, intra base prediction, or residual prediction) and quantizes/inversely quantizes the obtained residual. The prediction process may be predetermined. Thereafter, the macroblock 121 of the layer 0 is encoded. In such a manner, the macroblock 122 of the layer 1 has passed through the prediction process prior to the encoding of the macroblock 121 of the layer 0. Thus, information about whether the macroblock 121 of the layer 0 has been used in the prediction process or not can be obtained. Accordingly, it is possible to determine whether the macroblock 121 of the layer 0 is to be recorded as discardable information or non-discardable information.

Likewise, the video encoder obtains a residual for a macroblock 123 of a layer 2 through a prediction process (inter prediction, intra prediction, intra base prediction, or residual prediction), which may be predetermined, and quantizes/inversely quantizes the obtained residual. Thereafter, the macroblock 122 of the layer 1 is encoded. Lastly, the macroblock 123 of the layer 2 is encoded.

Approach 2: Utilization of Residual Energy

Approach 2 is to compute residual energy of the current macroblock and compare the same with a threshold value. The threshold value may be predetermined. The residual energy of a macroblock can be computed as the sum of the absolute value or square value of a coefficient within the macroblock. The greater the residual energy, the more the data to be coded.

If the residual energy of the current macroblock is smaller than the threshold value, the macroblock of an enhancement layer corresponding to the current macroblock is limited so as not to employ an inter-layer prediction scheme. In this case, the residual of the current macroblock is encoded into a discardable NAL unit. Conversely, if the residual energy of the current macroblock is greater than the threshold value, the residual of the current macroblock is encoded into a non-discardable NAL unit.

Compared to the approach 1, the approach 2 is disadvantageous in that a slight drop of PSNR may be caused.

As proposed in the present invention, discarding several residuals may lead to a reduction of computation complexity at a video decoder part. This is because parsing and inverse transform can be skipped for all macroblocks whose residuals are discarded. There is another way of reducing computation complexity without coding of an additional flag in a macroblock. That is to say, in order to indicate macroblocks that are not used in the residual prediction process of enhancement layers, the video encoder transmits Supplemental Enhancement Information (SEI) to the video decoder. The SEI is not included in a video bitstream but is included in data in accordance with the SVC standard as additional data or meta data transmitted together with the video bitstream.

Under the current SVC standard, the rate-distortion (RD) cost of base layer information is not taken into consideration while estimation of the current layer is being made, which is because the base layer information is non-discardable information and it is considered to exist in any circumstances.

However, under the circumstances where residual information about the current layer (a base layer on the basis of enhancement layers) is discardable, like in the present invention, it is necessary to take the RD cost for coding the residual of the current layer into consideration while performing residual prediction in the enhancement layers. This is accomplished by adding bits of the current macroblock to residual bits of the base layer while performing RD estimation. The RD estimation may lead to higher RD performance in the current layer after discarding the residual of the base layer.

Dead substream optimization of a fine granular scalability (FGS) layer using multiple layer rate-distortion (MLRD) can be implemented by extending the concept of the present invention. The dead substream is a substream necessary for decoding an enhancement layer. In the SVC standard, the dead substream is also called unnecessary pictures or discardable substream and can be identified by a discardable_flag in the NAL header. Alternatively, a method of indirectly determining whether a substream is a dead substream or not is to check a value of a base_id_plus1 of each of all enhancement layers and to determine whether the value of the base_id_plus1 is referred to the substream or not.

FIG. 14 is a diagram showing an example of a dead substream in a FGS video, to which multiple adaptation cannot be applied. Referring to FIG. 14, a FGS layer 0 is needed for decoding a layer 1 and a layer 0. Here, the CGS layers are base quality layers required for FGS implementation and are also called discrete layers.

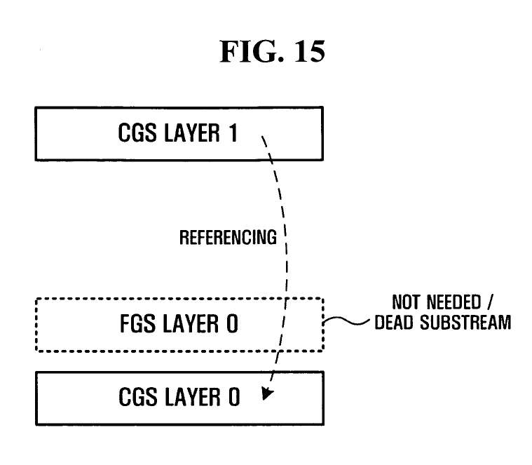

FIG. 15 is a diagram showing an example of a bitstream in a FGS video, to which multiple adaptation can be applied. Referring to FIG. 15, since a FGS layer is not used for inter-layer prediction, it may be discardable when only the layer 1 is to be decoded. Briefly, a FGS layer 0 may be discardable in a bitstream applied to the layer 1. However, when both the layer 0 and the layer 1 are needed to decode by a client, the FGS layer 0 cannot be discardable.

This allows for optimum trade-off between rate and distortion when multiple adaptation is necessary.

To implement RD optimization of a layer to be predicted, principles adopted in MLRD can be used.

Step 1: Use of inter-layer prediction starts from a base quality level (CGS layer 0). RD costs for frames in the CGS layer 0 are calculated.
FrameRd0=FrameDistortion+Lambda*FrameBits

Step 2: Use of inter-layer prediction starts from a quality level 1 (CGS layer 0). RD costs for frames in the CGS layer 0 are calculated.
FrameRd1=FrameDistortion+Lambda*(FrameBits+FGSLayer0Bits)

It is noted that the present inventive concept imposes a penalty on inter-layer prediction from a FGS layer in order to implement multiple adaptation.

Step 3: The RD costs are calculated to select an optimum cost. If FrameRD1 is smaller than FrameRD0, the frame can be applied to multiple adaptation (adaptation to the layer 1 in the illustrated example) in order to reduce a bitrate for a bitstream of the layer 1 only.

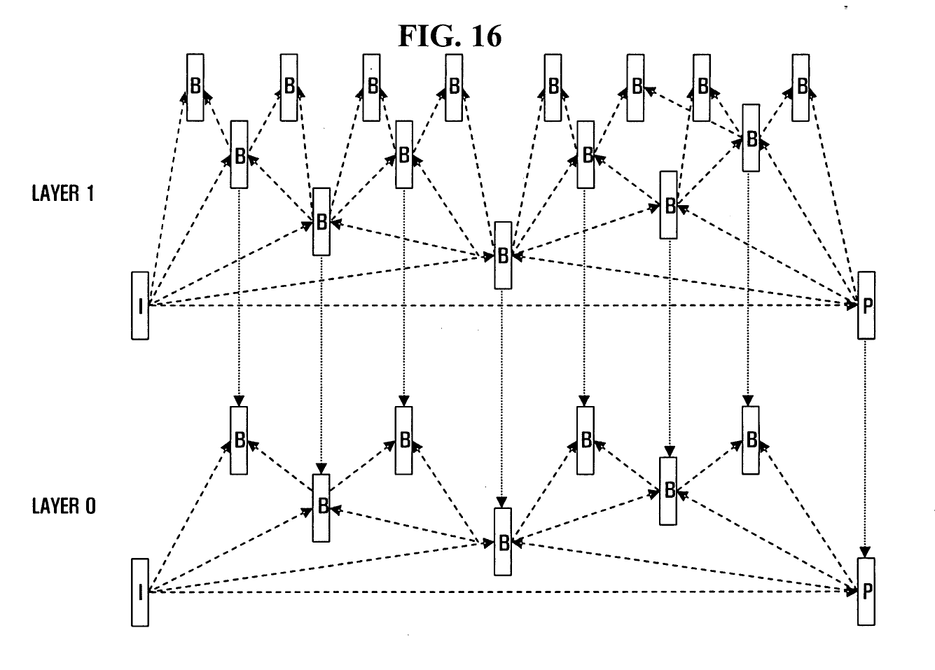

Concepts of the dead substream and multiple RD cost may also be extended from a temporal level standpoint. FIG. 16 is a diagram showing an example of multiple adaptation using temporal levels, illustrating concepts of a hierarchical B structure and inter-layer prediction under the SVC standard.

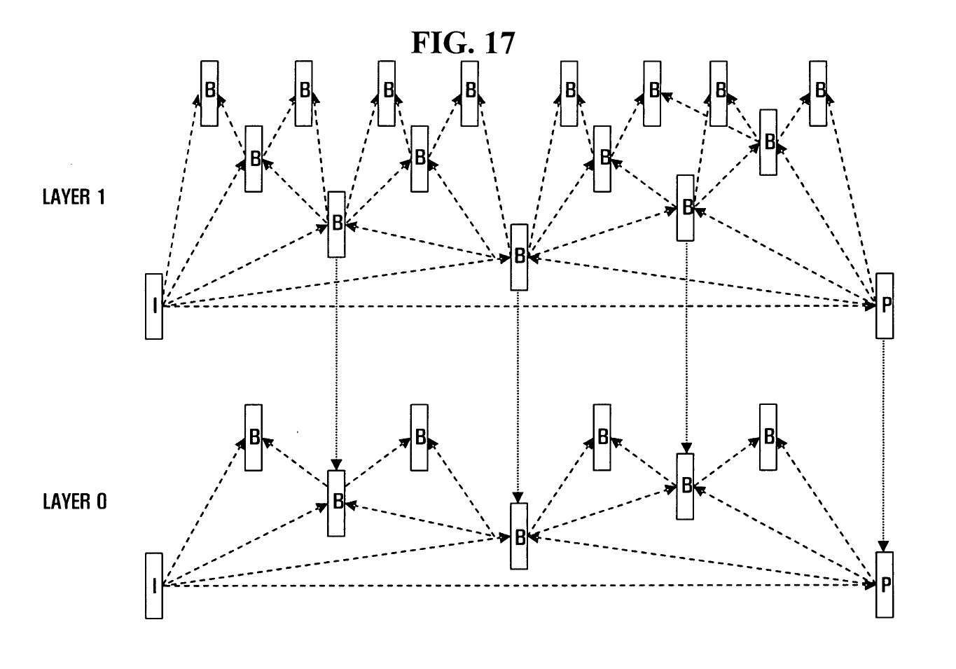

By contrast, referring to FIG. 17 showing an example of multiple adaptation using temporal levels in accordance with an exemplary embodiment of the present invention, inter-layer prediction is not used from the topmost temporal level, i.e., layer 0. This means that the topmost temporal level, i.e., layer 0, is not needed for the bitstream of the layer 1 only, which is applied to adaptation to decode the layer 1 only, and then is discardable. Determination whether to use inter-layer prediction or not may be accomplished by multiple RD estimation.

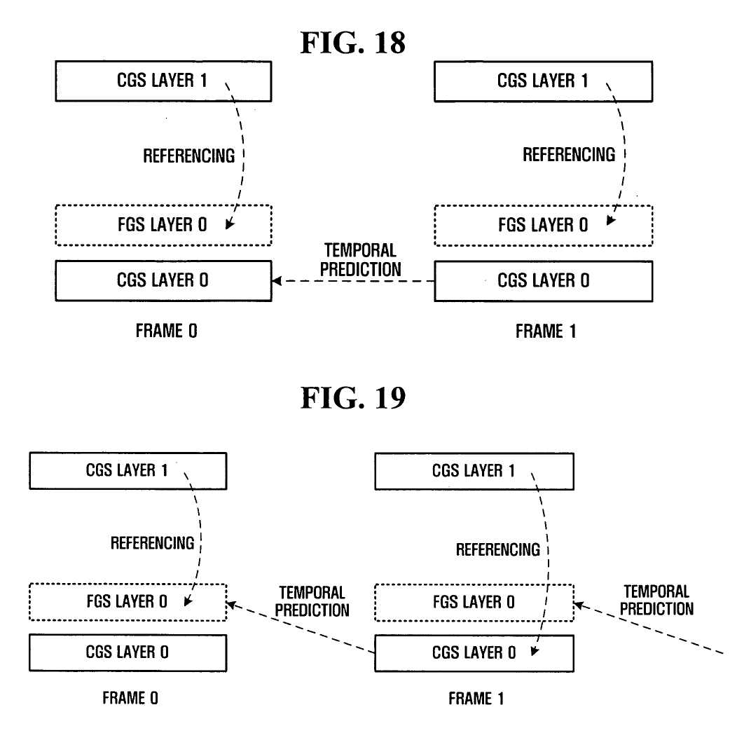

FIG. 18 is a diagram showing an example of temporal prediction between CGS layers. A bitstream shown in FIG. 18 can be decoded in the layer 0, which is because the FGS layer 0 is not used in temporal prediction of the layer 0. That is to say, the bitstream applied to adaptation to decode the layer 1 can be decoded still in the layer 0, which, however, does not hold true in all circumstances. It may not hold true in such a case shown in FIG. 19.

The layer 0 uses a closed loop prediction scheme for temporal prediction. This means that truncation or discarding of the FGS layer 0 results in drift/distortion when decoding the layer 0. In such a circumstance, if the bitstream is applied to adaptation to decode the layer 1 by discarding the FGS layer 0 of frame 1, a problem, such as a drift error or a drop of PSNR, may be caused when decoding the layer 0 using the bitstream.

In general, the client would not decode the layer 0 based on the bitstream adopted for the layer 1. However, if it is not revealed that the bitstream is adopted for the layer 1, the layer 0 may be decoded based on the adopted for the layer 1. Therefore, the present invention additionally proposes using the following information as a separate part of a Supplemental Enhancement Information (SEI) message.

scalability_info( payloadSize )
...

multiple_adaptation_info_flag[i]

...

if (multiple_adaptation_info_flag[ i ]) {

can_decode_layer[i]
if(can_decode_layer[i])
{

decoding_drift_info[i]

}

}

}

The “can_decode_layer[i]” flag indicates whether a given layer can be decoded or not. If the given layer can be decoded, it is possible to transmit information about drift that may occur.

In the SVC standard, RD performance of a FGS layer is indicated using the SEI message for quality layer information. The RD performance shows how much a FGS layer of an access unit is sensitive to a truncation or discarding process. In the hierarchical B structure, for example, I and P pictures are considerably sensitive to a truncation or discarding process. In a higher temporal level, however, pictures will not be sensitive to a truncation or discarding process. Thus, an extractor can optimally truncate FGS layers at various access units using the above information proposed as the separate part of the SEI message. The present invention proposes the SEI message for quality layer information having the following format:

quality_layers_info( payloadSize ) {

dependency_id
num_quality_layers
for( i = 0; i < num_quality_layers; i++ ) {

quality_layer[ i ]
delta_quality_layer_byte_offset[ i ]

}

}

The message for the current quality layer is defined as the quality/rate performance for the current layer, i.e., the quality/rate performance when the FGS layer of the current layer is discarded. As previously illustrated, however, the FGS layer of the base layer can be discarded in a case of multiple adaptation. Thus, the following interlayer quality layer SEI message can be transmitted between layers. A drift error occurring due to truncation of the FGS layer depends upon interlayer prediction performance with regard to temporal prediction.

interlayer_quality_layers_info( payloadSize ) {

dependency_id
base_dependency_id
num_quality_layers
for( i = 0; i < num_quality_layers; i++ ) {

interlayer_quality_layer[ i ]
interlayer_delta_quality_layer_byte_offset[ i ]

}

}

When there is a necessity of truncating a bitstream, the bitstream extractor may determine whether a FGS layer of the current layer or a FGS layer of the base layer is to be truncated depending on quality_layers_info and interlayer_quality_layers_info SEI message.

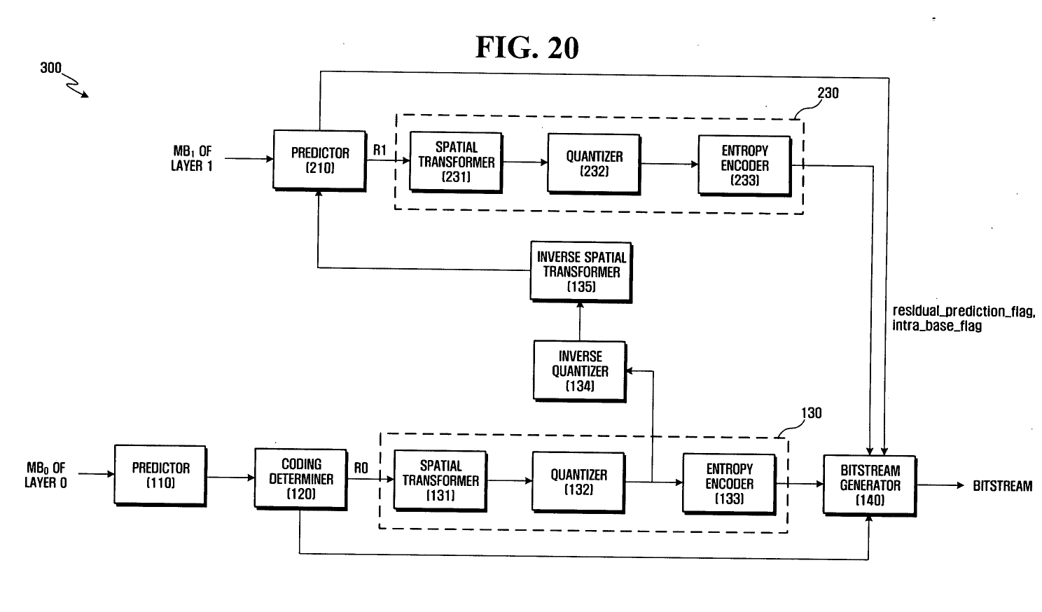

FIG. 20 is a block diagram of a video encoder 300 in accordance with an exemplary embodiment of the present invention.

A macroblock MB₀ of a layer 0 is input to a predictor 110 and a macroblock MB₁ of a layer 1, which temporally and spatially corresponds to the macroblock MB₀ of the layer 0, is input to a predictor 210, respectively.

The predictor 110 obtains a predicted block using inter prediction or intra prediction and subtracts the obtained predicted block from MB₀ to obtain a residual R0. The inter prediction includes a motion estimation process of obtaining motion vectors and macroblock patterns and a motion compensation process of motion-compensating for frames referred for by the motion vectors.

A coding determiner 120 determines whether or not it is necessary to perform coding the obtained residual R0. That is to say, when the energy of the residual R0 is smaller than a threshold value, it is determined that values falling within the range of the residual R0 are all considered as being 0, and the coding determiner 120 notifies the determination result of a coding unit 130. The threshold value may be predetermined.

The coding unit 130 performs coding on the residual R0. To this end, the coding unit 130 may comprise a spatial transformer 131, a quantizer 132, and an entropy coding unit 133.

The spatial transformer 131 performs spatial transform on the residual R0 to generate transform coefficients. A Discrete Cosine Transform (DCT) or a wavelet transform technique or other such technique may be used for the spatial transform. A DCT coefficient is generated when DCT is used for the spatial transform while a wavelet coefficient is generated when wavelet transform is used.

The quantizer 132 performs quantization on the transform coefficients. Here, quantization is a methodology to express the transform coefficient expressed in an arbitrary real number as discrete values. For example, the quantizer 132 performs the quantization by dividing the transform coefficient by a predetermined quantization step and rounding the result to an integer value.

The entropy coding unit 133 losslessly encodes the quantization result provided from the quantizer 132. Various coding schemes such as Huffman Coding, Arithmetic Coding, and Variable Length Coding, or other similar scheme, may be employed for lossless coding.

To enable the quantization result provided from the quantizer 132 to be used in inter-layer prediction in a predictor 210 of the layer 1, the quantization result is subjected to an inverse quantization process performed by an inverse quantizer 134 and an inverse transformation process performed by an inverse spatial transformer 135.

Since the macroblock MB₀ of the layer 0 corresponding to MB1 exists, a predictor 210 can use inter-layer prediction, e.g., intra base prediction or residual prediction, as well as inter prediction or intra prediction. The predictor 210 selects a prediction scheme that offers the minimum RD cost among a variety of prediction schemes, obtains a predicted block for MB₁ using the selected prediction scheme, subtracts the predicted block from MB₁ to obtain a residual R1. Here, if the predictor 210 uses inter-layer prediction, intra_base_flag is set to 1 (if not, intra_base_flag is set to 0). If the predictor 210 uses residual prediction, residual_prediction_flag is set to 1 (if not, residual_prediction_flag is set to 0).

Like in the layer 0, a coding unit 230 performs coding on the residual R1. To this end, the coding unit 230 may comprise a spatial transformer 231, a quantizer 232, and an entropy coding unit 233.

In addition, a bitstream generator 140 generates a switched scalable bitstream according to an exemplary embodiment of the present invention. To this end, if the coding determiner 120 determines that it is not necessary to code the residual R0 of the current macroblock, the bitstream generator 140 sets a CBP flag to 0 with the residual R0 excluded from the bitstream of the current macroblock. Meanwhile, if the residual R0 is actually coded in the coding unit 230 and then supplied to the bitstream generator 140, the bitstream generator 140 determines whether or not MB₁ has been inter-layer predicted by the predictor 210 (using intra base prediction or residual prediction), which can be accomplished by reading residual_prediction_flag or intra_base_flag provided from the predictor 210.

As the determination result, if MB₁ has been inter-layer predicted, the bitstream generator 140 records data of the coded macroblock on a non-discardable unit region. If MB, has not been inter-layer predicted, the bitstream generator 140 records the data of the coded macroblock on a discardable unit region and sets the CBP flag thereof to 0 to then be recorded on the non-discardable NAL unit region. In the non-discardable unit region (80 of FIG. 11), a discardable_flag is set to 0. In the discardable NAL unit region (90 of FIG. 11), a discardable_flag is set to 1. In such a manner, the bitstream generator 140 generates the bitstream of the layer 0, as shown in FIG. 11, and generates a bitstream of the layer 1 from the coded data provided from the coding unit 230. The generated bitstreams of the layers 1 and 2 are combined to then be output as a single bitstream.

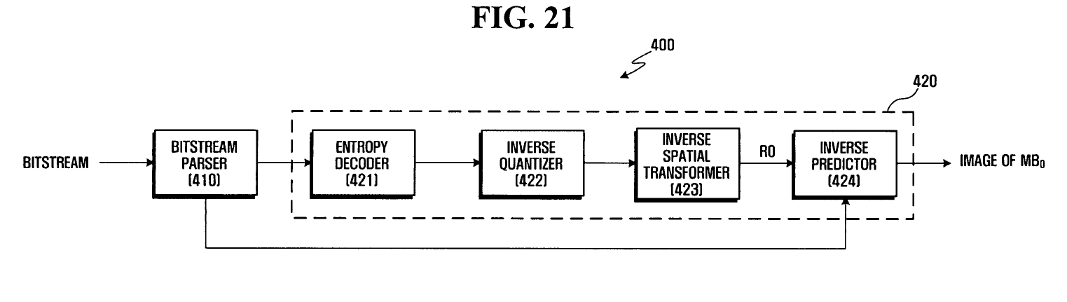

FIG. 21 is a block diagram of a video decoder 400 according to an exemplary embodiment of the present invention. Referring to FIG. 21, like in FIG. 11, an input bitstream includes discardable information and non-discardable information.

A bitstream parser 410 reads a CBP flag of the current macroblock contained in the non-discardable information from the NAL unit. A value of the discardable_flag recorded in a NAL unit header indicates whether or not the NAL unit is discardable or not. If the read CBP flag is 1, the bitstream parser 410 reads data recorded on the current macroblock and supplies the read data to a decoding unit 420.

If there is no macroblock having the same identifier as the current macroblock in the discardable NAL unit, it is notified an inverse predictor 424 that the current macroblock is not available, i.e., the read data are all 0.

The decoding unit 420 decodes the macroblock data supplied from the bitstream parser 410 to restore an image for a macroblock of a predetermined layer. To this end, the decoding unit 420 may include an entropy decoder 421, an inverse quantizer 422, an inverse spatial transformer 423, and the inverse predictor 424.

The entropy decoder 421 performs lossless decoding on the bitstream. The lossless decoding is an inverse operation of the lossless coding performed in the video encoder 300.

The inverse quantizer 422 performs inverse quantization on the data received from the entropy decoder 421. The inverse quantization is an inverse operation of the quantization to restore values matched to indexes using the same quantization table as in the quantization which has been performed in the video encoder 300.

The inverse spatial transformer 423 performs inverse spatial transform to reconstruct a residual image from coefficients obtained after the inverse quantization for each motion block. The inverse spatial transform is an inverse spatial transform operation performed by the video encoder 300. The inverse spatial transform may be inverse DCT transform, inverse wavelet transform, or the like. As the result of the inverse spatial transform, the residual R0 is restored.

That is, the inverse predictor 424 inversely restores the residual R0 in a manner corresponding to that in the predictor 110 of the video encoder 300. The inverse prediction is performed by adding the residual R0 to the predicted block, like the prediction performed in the predictor 110.

The respective components described in FIGS. 20 and 21 may be implemented in software including, for example, task, class, process, object, execution thread, or program code, the software configured to reside on a predetermined area of a memory, hardware such as a Field Programmable Gate Array (FPGA) or Application Specific Integrated Circuit (ASIC), which performs certain tasks, or a combination of software and hardware. The components may be stored in computer readable storage media, or may be implemented such that they execute one or more computers.

As described above, according to the present inventive concept, coding performance of a video based on multiple layers can be enhanced.

In addition, when scalability of a scalable bitstream is not necessarily supported, the present invention can reduce an overhead of the scalable bitstream.

While the present inventive concept has been particularly shown and described with reference to exemplary embodiments thereof, it will be understood by those of ordinary skill in the art that various changes in form and details may be made therein without departing from the spirit and scope of the present invention as defined by the following claims. Therefore, it is to be understood that the above-described exemplary embodiments have been provided only in a descriptive sense and will not be construed as placing any limitation on the scope of the invention.

What is claimed is:

1. A video encoding method for encoding a video sequence having a plurality of layers, the method comprising:
coding a residual of a first block existing in a first layer among the plurality of layers;
recording the coded residual of the first block on a non-discardable region of a bitstream, if a second block is coded using the first block, the second block existing in a second layer among the plurality of layers and corresponding to the first block; and
recording the coded residual of the first block on a discardable region of the bitstream, if a second block is coded without using the first block.

2. The method of claim 1, wherein the first block and the second block are macroblocks.

3. The method of claim 1, wherein the non-discardable region comprises a plurality of Network Abstraction Layer (NAL) units having discardable_flag set to 0 and the discardable region comprises a plurality of NAL units having discardable_flag set to 1.

4. The method of claim 1, wherein the coding of the residual comprises performing spatial transform, quantizing, and entropy coding.

5. The method of claim 1, wherein the recording of the coded residual of the first block on the non-discardable region comprises setting the coded block pattern (CBP) flag for the recorded residual of the first block to 1.

6. The method of claim 1, wherein the recording of the coded residual of the first block on the discardable region comprises setting the coded block pattern (CBP) flag for the recorded residual of the second block to 0 and recording the CBP flag on the non-discardable region.

7. The method of claim 1, wherein if the second block is coded using the first block, the second block is inter-layer predicted.

8. The method of claim 1, wherein if the second block is coded without using the first block, the second block is inter predicted or intra predicted.

9. The method of claim 1, wherein the non-discardable region and the discardable region are represented by Supplemental Enhancement Information (SEI) messages.

10. A video decoding method for decoding a video bitstream including at least one layer having a non-discardable region and a discardable region, the method comprising:
reading a first block from the non-discardable region;
decoding data of the first block if the data of the first block exists;
reading data of a second block having a same identifier as the first block from the discardable region if no data of the first block exists; and
decoding the read data of the second block.

11. The method of claim 10, wherein existence of the data of the first block is determined by a coded block pattern (CBP) flag of the first block.

12. The method of claim 10, wherein the first block and the second block are macroblocks.

13. The method of claim 12, wherein the identifier is a number identifying a macroblock.

14. The method of claim 10, wherein if the data of the first block exists, a coded block pattern (CBP) flag of the first block recorded on the non-discardable region is set to 1, and if no data of the first block exists, the CBP flag of the first block recorded on the non-discardable region is set to 0.

15. The method of claim 10, wherein the at least one layer comprises a topmost layer among a plurality of layers.

16. The method of claim 10, wherein the non-discardable region comprises a plurality of Network Abstraction Layer (NAL) units having discardable_flag set to 0 and the discardable region comprises a plurality of NAL units having discardable_flag set to 1.

17. The method of claim 10, wherein the non-discardable region and the discardable region are represented by Supplemental Enhancement Information (SEI) messages.

18. The method of claim 17, wherein the SEI messages are generated by a video encoder.

19. The method of claim 10, wherein each of the decoding of the first block data and the decoding of the second block data comprises performing spatial transform, quantizing, and entropy coding.

20. A video encoder for encoding a video sequence having a plurality of layers, the video encoder comprising:
a coding unit that codes a residual of a first block existing in a first layer among the plurality of layers;
a recording unit that records the coded residual of the first block on a non-discardable region of a bitstream, if a second block is coded using the first block, the second block existing in a second layer among the plurality of layers and corresponding to the first block; and
a recording unit that records the coded residual of the first block on a discardable region of the bitstream, if a second block is coded without using the first block.

21. A video decoder for decoding a video bitstream comprising at least one layer having a non-discardable region and a discardable region, the video decoder comprising:
a reading unit that reads a first block from the non-discardable region;
a decoding unit that decodes data of the first block if the data of the first block exists;
a reading unit that reads data of a second block having a same identifier as the first block from the discardable region if no data of the first block exists; and
a decoding unit that decodes the read data of the second block.
